(19) United States
(12) Patent Application Publication
(10) Pub. No.: US 2008/0271503 A1
(43) Pub. Date: Nov. 6, 2008

(54) Lock, in Particular for Automotive Doors, Flaps or the Like

(76) Inventor: Gerd Buschmann, Velbert (DE)

Correspondence Address: FRIEDRICH KUEFFNER, 317 MADISON AVENUE, SUITE 910, NEW YORK, NY, 10017, US

(21) Appl. No.: 10/593,056

(22) PCT Filed: Mar. 4, 2005
(86) PCT No.: PCT/EP05/02274

§ 371 Date: Sep. 15, 2006

(51) Int. Cl. E05B 65/12

(52) U.S. Cl. 70/237

(57) ABSTRACT

A lock comprises a rotary latch (10) with a pre-latch position (12) and a main latch position (11), the latch being retained by a catch (20). A combined, power-driven closing and opening aid ensures an increased comfort when closing or opening the door by means of two drive elements (50, 60) that can be moved simultaneously, namely a closing element (50) and an opening element (60). In order to obtain a compact lock, both drive elements (50, 60) are arranged on a common drive wheel (40) with a mutual axial offset. Moreover, the closing element (50) is movable relative to the opening element (60) in two rotation planes which are axially offset relative to one another. A carrier (14) is also provided on the rotary latch (10), in the plane of the closing element (50), while the catch (20) has a release finger (23) arranged in the plane of the opening element. The opening element (60) is resiliently received in the drive wheel (40) and can be automatically moved between a retracted position and an extended position.

The invention pertains to a lock of the type indicated in the introductory clause of Claim 1. The combination motorized closing and opening aid provided makes it easier to close and open the door. A motor, which is controlled by a control unit, puts a gear into motion in one direction or the other. This gear has two takeoff elements, one of which functions as a closing aid, the other as an opening aid. These two elements are therefore referred to in the following as the “closing element” and the “opening element”, respectively. The two takeoff elements are permanently connected to the gear and are therefore always put into motion simultaneously.

In the known lock of this type (DE 101 33 092 A1), the two takeoff elements always proceed in opposite directions when actuated. For this reason, two separate takeoff wheels are required. These occupy a large amount of space. The two takeoff wheels must be of adequate size, and the takeoff elements must be mounted on them with a rotational offset from each other so that their two paths of movement do not intersect. After both the closing process and the opening process have been completed, the motor returns the two takeoff elements from their extreme positions to a middle position. This requires a complicated control system, which occupies a considerable amount of space.

The invention is based on the task of developing a reliable lock of the type cited in the introductory clause of Claim 1 in such a way that it occupies much less space. This is achieved according to the invention by means of the measures stated in Claim 1, to which the following special meaning attaches.

For the mounting of the two takeoff elements, it is enough to provide a single takeoff wheel, on which both of these elements are seated jointly. As a result, the previously required second takeoff wheel is eliminated and space is saved. When the takeoff wheel turns and the paths of movement of the two takeoff elements intersect, there is, however, no interference with the proper functioning of the device for the following reason:

The closing element, which brings about the closing process, lies in a first plane of rotation in the lock, which is to be called the “closing plane”, whereas the opening element responsible for the opening process lies in a second plane of rotation, axially offset from the first plane. This second plane is therefore to be called the “opening plane”. The rotary latch has a driver, mounted in the closing plane, for the closing element. When the latch is in the open position, the driver is located outside the rotational path of the closing element, but when the latch is in the prelatching position or in the main latching position, the driver is in the rotational path of the closing element. The pawl has a release finger, positioned in the opening plane, for the opening element. The opening element is mounted with spring-loading in the takeoff wheel and, because of its spring-loading, shifts position automatically with respect to the release finger. When the release finger is pressing on the opening element, the element is kept in its inactive, retracted position, but when the release finger releases the opening element, the element travels into its active, extended position. Thus, even though the two elements are mounted on the same takeoff wheel, there can be no interference with the proper functioning of the lock. The lock always operates reliably.

It is advantageous with respect to the control of the common takeoff wheel for the reversal points of its movement to be located in the two end positions. When the door is open, therefore, the takeoff wheel is located in the one end position, which, for this reason is called the “open end position”. If the takeoff wheel is in the open end position and is then turned in a certain direction, it ultimately reaches its other end position, in which the door is closed. This second end position is therefore called the “closed end position”. To reach these two end positions, it is sufficient to let the motorized drive operate until all the parts have moved into solid contact with each other, whereupon the control unit stops the motor in the end position, i.e., stops the rotation or counterrotation of the takeoff wheel.

Additional measures and advantages of the invention can be derived from the subclaims, from the following description, and from the drawings. Although the drawings show only a single exemplary embodiment, this embodiment is shown in various phases of operation and in various operating situations:

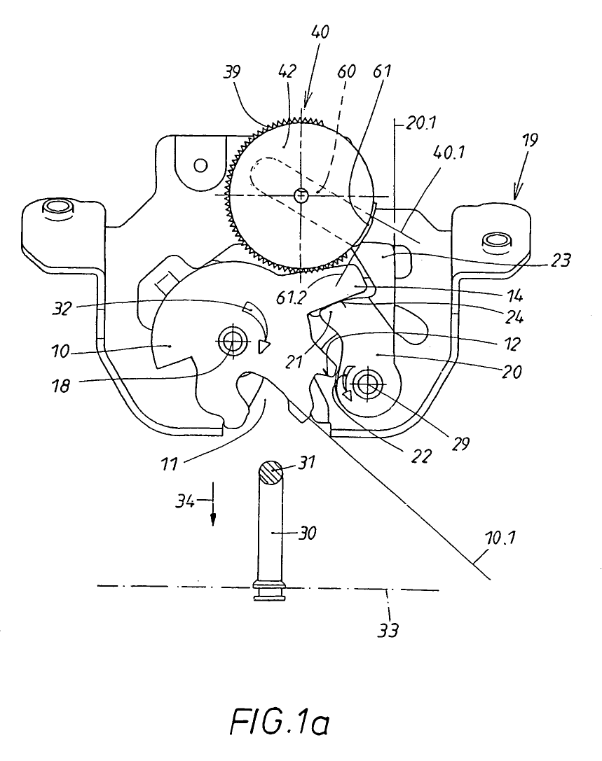

FIG. 1a shows a front view of the lock with the rotary latch in its open position;

FIG. 1b shows a rear view of the same lock in the same phase of operation;

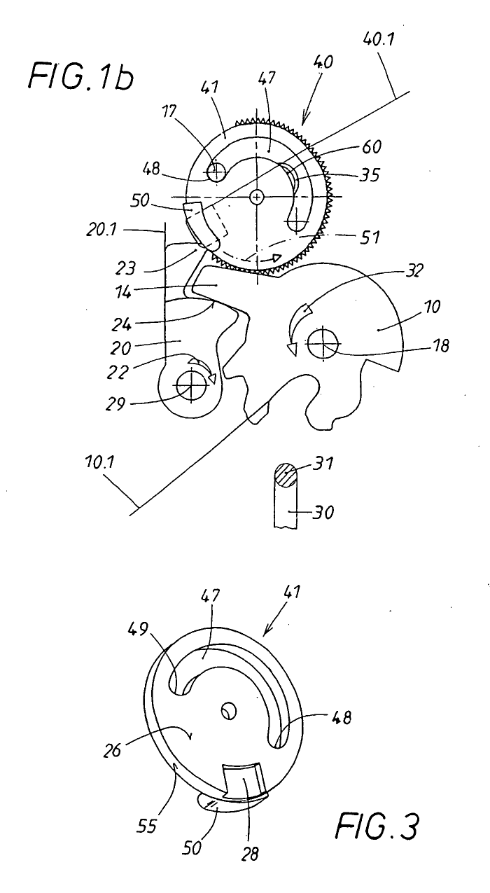

FIG. 2 shows a perspective exploded view of the most important components of the lock;

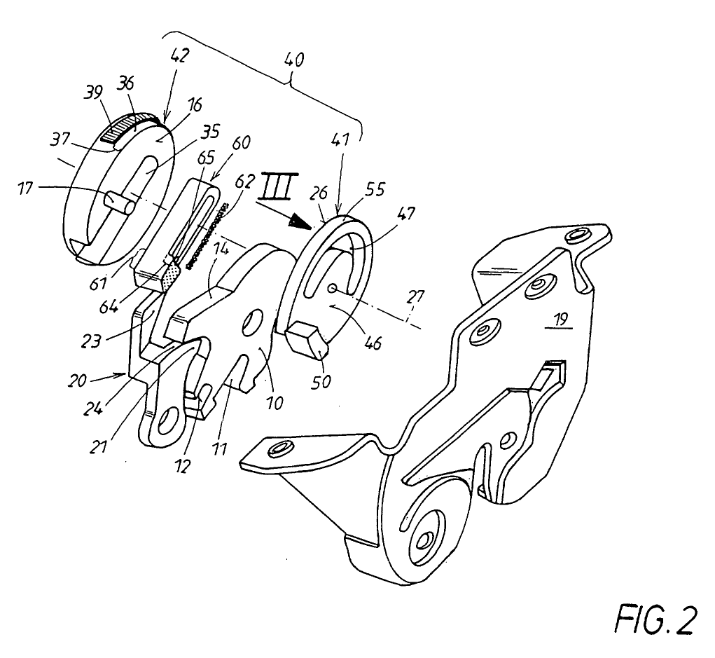

FIG. 3 also shows a perspective view of a component of the lock shown in FIG. 2, namely, a cam disk, looking in the direction of the arrow III of FIG. 2;

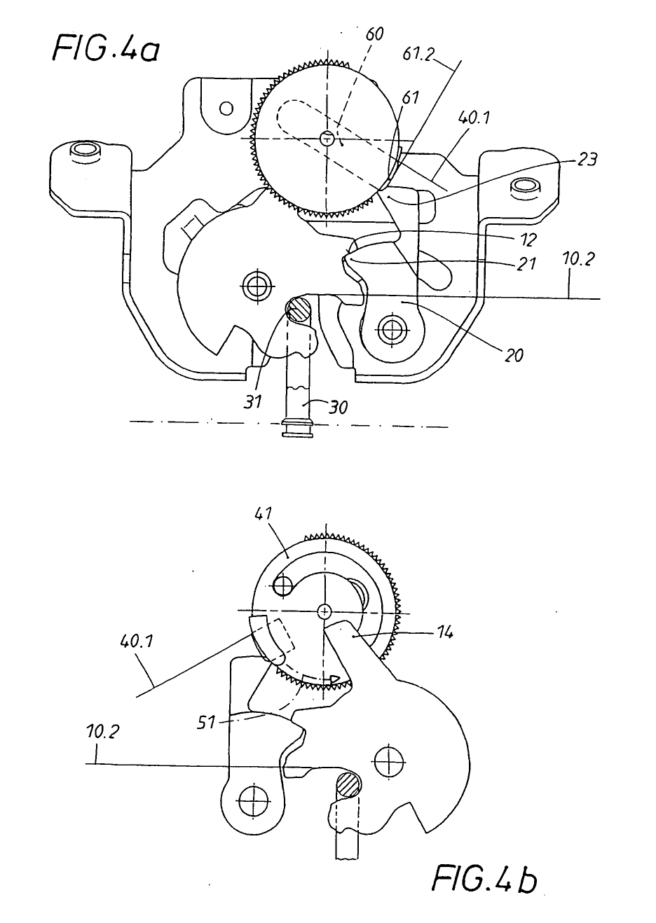

FIGS. 4a+4b show, in analogy to FIGS. 1a and 1b, front and rear views of the lock after a rear hatch of a vehicle equipped with this lock has been closed to the extent that the rotary latch has arrived in its prelatching position;

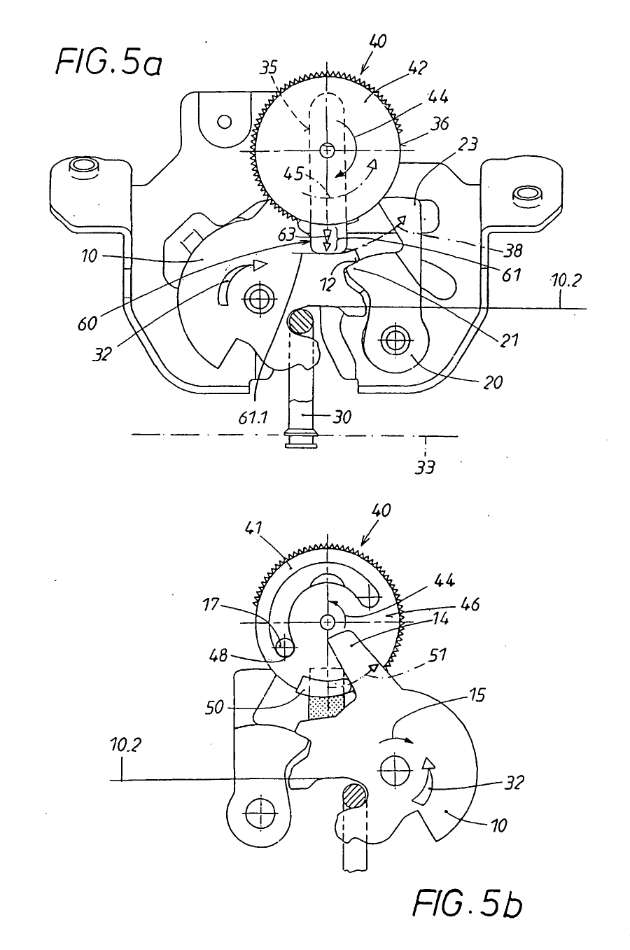

FIGS. 5a+5b show front and rear views of a subsequent operating phase of the lock, where a motor has turned a takeoff wheel to a certain extent in one direction from its original open end position;

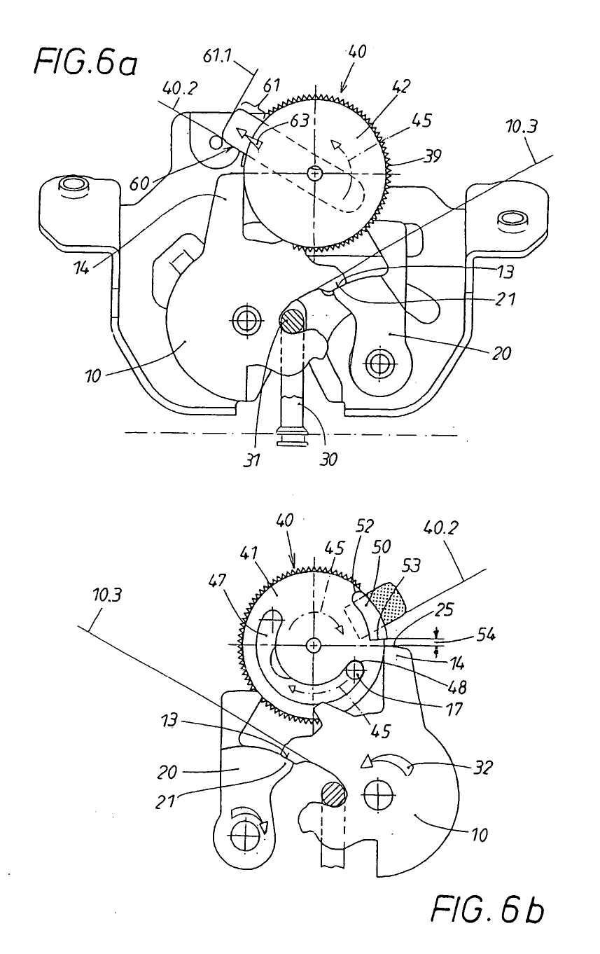

FIGS. 6a+6b show front and rear views of the lock in an operating phase in which the takeoff wheel has been moved into its other end position, i.e., the closed end position, and stopped there, the rotary latch having dropped into its main latching position;

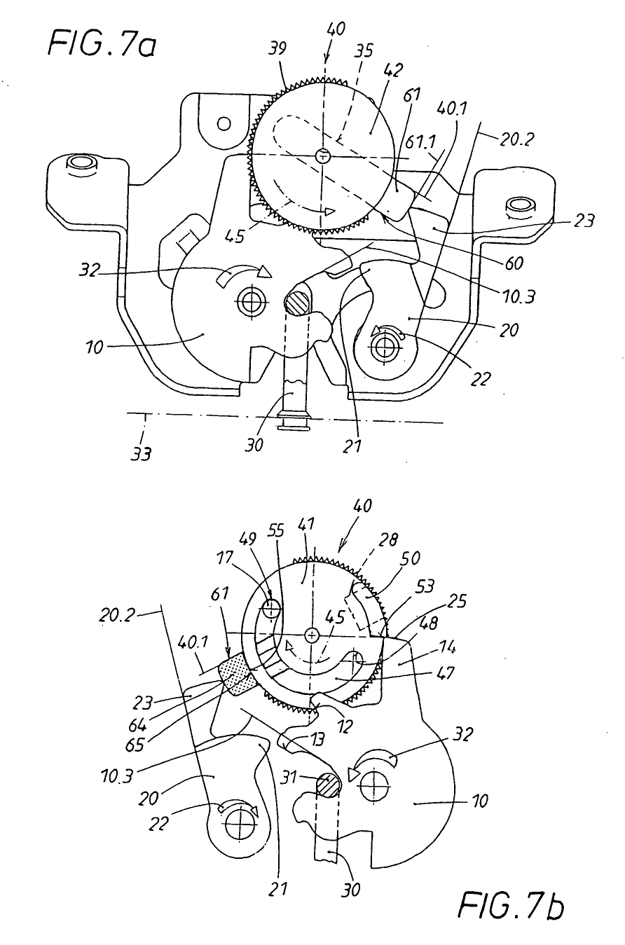

FIGS. 7a+7b show front and rear views of the lock after the takeoff wheel has rotated in reverse back to its open end position, although here it is in a so-called “snow load” situation, where, because of the icing-up of the rotary latch or because of a load of snow acting on the rear hatch, the rotary latch is unable to move back under the effect of its spring-loading to its open position but has been released by a pawl.

Let it be assumed that the inventive lock shown in Figures is mounted in the rear hatch of a vehicle (not shown). A lock of this type could, of course, also be installed in a door. In FIGS. 1a and 1b, the rear hatch is open. A front view of a housing 19 appears in FIG. 1a, but the housing has been omitted from the rear view in FIG. 1b. A rotary latch 10 is supported on an axis of rotation 18 in this housing. The force of a spring, indicated by the arrow 32, acts on the rotary latch 10. When the hatch is open, the rotary latch 10 is kept in the open position, illustrated by the auxiliary line 10.1, by the spring-loading 32.

The rotary latch 10 has a receptacle 11 for a closing yoke 30, which is permanently attached to the body 33 of the automobile, indicated in dash-dot line. In the drawings, one of the sidepieces of the yoke has been cut away, for which reason the yoke web 31, emphasized by shading, is visible. When the hatch is open, the yoke web 31 is located a certain distance away from the lock. When the hatch is moved in the closing direction as indicated by the arrow 34 of FIG. 1a, the yoke web 31 travels into the receptacle 11 and rotates the latch 10 into the prelatching position shown in FIGS. 4a and 4b and illustrated by the auxiliary line 10.2. This prelatching position is determined by a pawl 20.

As FIG. 1a shows, the pawl 20 is rotatably supported at 29 in the housing 19 and is under the action of a spring (not shown). The spring exerts a spring load, illustrated by the force arrow 22, on the pawl 20. The pawl 20 has not only a locking point 21 but also a release finger 23, located on an extension of the pawl. In the open position 10.1 of FIGS. 1a and 1b, this release finger is supported on a takeoff element 50, to be described in greater detail further below, of a single takeoff wheel 40. The pawl 20 thus now occupies the “ready-to-lock” position illustrated by the auxiliary line 20.1 in FIGS. 1a and 1b. The open position 10.1 of the rotary latch 10 is determined by the fact that a driver 14 on the rotary latch 10 is supported against an offset shoulder 24 of the pawl 20. As can be seen best in FIG. 2, the pawl locking point 21 is formed by the inner end of the pawl shoulder 24.

When the prelatching position 10.2 of FIGS. 4a and 4b is present, however, the locking point 21 grips a prelatching element 12 on the rotary latch 20. At this point a claw, forming one of the boundaries of the receptacle 11 of the rotary latch 10, grips the yoke web 31 of the yoke 30, which has traveled into the receptacle. Even though the yoke 30 is thus engaged in the rotary latch 10, there is still a gap between the rear hatch and the automobile body 33. The job now is to close this gap, which is done in motorized fashion by means of a combination closing and opening aid.

In the present case, the closing and opening aid is integrated into the takeoff wheel 40, and the takeoff wheel 40 consists of two disks 41, 42, to be described in greater detail further on. This is illustrated most clearly in the exploded view of FIG. 2. The takeoff wheel 40, however, can also have a compact design, in which the two disks 41, 42 always move together in the same way. In this case, the wheel could therefore be easily designed as a one-piece unit. This exemplary embodiment (not shown in detail) is to be described first, but the description also applies to the exemplary embodiment which is shown, namely, the embodiment with the two disks 41, 42, which can move relative to each other under certain conditions. This conditional mobility will be described in detail further below.

The closing and opening aid comprises a motor (not shown) and a gear (not shown), at the end of which the takeoff wheel 40 is mounted. In the open position 10.1 and in the prelatching position 10.2 of the rotary latch, the takeoff wheel 40 is located in its one end position, which is illustrated by the auxiliary line 40.1. Because this end position 40.1 according to FIGS. 1a and 1b is present when the door is open, it is to be called the “open end position”. Two takeoff elements 50, 60 are integrated into the takeoff wheel 40. The first element 50 acts during the closing process and is therefore called the “opening element”. When a sensor detects the prelatching position of FIGS. 4a and 4b, a control unit (not shown) starts the motor in one direction, as a result of which the takeoff wheel turns in the direction marked by the rotation arrow 44 in FIGS. 5a and 5b.

The first takeoff element 50, which determines the closing process, is to be called the “closing element”, whereas the second takeoff element 60, which determines the opening process, is to be called the “opening element”. The closing element 50 is assigned to the previously mentioned disk 41 of the takeoff wheel 40 and consists of a cam, to be called the “closing cam”, which projects from the rear surface of the disk. For the same reason, this disk 41 is to be called the “cam disk”. This closing cam 50 is located outside the actual plane of rotation of the two disks 41, 42 and lies in the same plane as the rotary latch 10 and the profiled parts around its periphery, which include not only the previously described prelatching element 12 but also the driver tooth 14 and a main latching element 13, to be described later. In FIG. 5b, the rotational path 51 of the closing cam 50 during the rotation 44 of the takeoff wheel 40 is indicated by an arrow 51. Whereas, in the open position 10.1 of FIG. 1b, the driver tooth 14 is still located outside the rotational path 15, illustrated in dash-dot line, of the closing cam 50, the driver tooth 14 in FIG. 4b projects into the rotational path 51. Therefore, during this rotation 44, as illustrated in FIG. 5b, the closing cam 50 strikes the driver tooth 14. As a result, the rotary latch 10 is carried along and pivoted in the direction of the motion arrow 15 of FIG. 5b against its spring-loading 32.

The motor stops when the takeoff wheel 40 has reached its other end position, which is indicated in FIGS. 6a and 6b by the auxiliary line 40.2. This end position 40.2 is reached after the locking point 21 of the pawl has dropped behind the main latching element 10.3 of the rotary latch 10. Then the hatch is closed. For this reason, this end position 10.2 is called the “closed end position”. The yoke web 31 of the closing yoke 30 has now penetrated all the way into the lock and is held by the latch 10. As already mentioned, the main latching element 13, the prelatching element 12, and the driver tooth 14 represent profiled parts on the periphery of the rotary latch 10. In the closed end position 40.2, the motor stops. This can be brought about by an end stop, against which the motor travels. Sensors can also be used, however, to detect this closed end position 40.2 and to stop the motor by sending a signal to the control unit.

The second takeoff element on the takeoff wheel 40, namely, the opening element 60, is located in a plane of rotation in the lock which is axially offset from the closing element 50; by analogy, this plane is to be called the “opening plane”. The axial offset between the closing plane and the opening plane is easiest to see in FIG. 2 on the basis of the pawl 20. Whereas the locking point 21 of the pawl is in the closing plane of the rotary latch 10, its release finger 23 is axially offset and lies in the opening plane, in which the opening element 60 is also located. The opening element 60 consists in the present case of a slider, which is held in a channel 35, best seen in FIG. 2, and guided longitudinally therein. This guide channel 35 extends in the present case essentially along a diameter of the second disk 42, which is therefore to be called the “slider disk”. The slider 60 is under the action of a spring 62, which can be seen in FIG. 2, and which tries to push the end 61 of the slider out beyond the periphery 36 of the slider disk 42, as can be seen in FIG. 5a. The extended position of the slider end 61 is marked here by the auxiliary line 61.1.

In the open end position 40.1 of the takeoff wheel of FIGS. 1a and 4b, the end 61 of the slider is aligned with the release finger 23 of the pawl 20. The release finger 23 is thus now exerting pressure on the slider 60, as a result of which the slider 60 is pressed into its retracted position, illustrated by the auxiliary line 61.2. During the previously described motorized rotation 44 of the takeoff wheel 40, the end 61 of the slider leaves the release finger 23, which can then rest against the previously mentioned peripheral contour 36 of the slider disk 42, namely, against the support zone 37 designated 37 in FIG. 2. The spring 62, which can be seen in FIG. 2, generates an elastic force, illustrated by the force arrow 63 in FIG. 5a, which pushes the slider 60 back again into its extended position 61.1. End stops (not shown) are provided to ensure that the slider end 61 projects by the desired amount when in its extended position 61.1.

In FIG. 5a, as already mentioned, the rotary latch 10 is still in its prelatching position 10.2 The closing yoke 30 has still not traveled inward far enough, as a result of which there is still a gap between the automobile body 33 and the rear hatch. If then the emergency should occur that the rotation 44 of the takeoff wheel 40 must be stopped, because, for example, an object threatens to become jammed in the gap, the lock can be opened quickly again by having the motor turn in the opposite direction. During this reverse rotation of the motor, the takeoff wheel 40 and thus the slider disk 42 are turned in the opposite direction, as shown by the movement arrow 45 in dash-dot line in FIG. 5a. The rotational path of the extended end 61 of the slider thus produced is indicated in FIG. 5a by a dash-dot rotational arrow 38. During this rotation in the opposite direction, the end 61 of the slider strikes the side of the release finger 23 and thus lifts the locking point 21 of the pawl 20 out of the prelatching element 12 of the rotary latch 10. Under the effect of its spring-loading force 32, the rotary latch 10 can then return automatically to the open position of FIG. 1a. In this way, the slider 60 functions as an opening aid for the rear hatch.

FIGS. 7a and 7b show that the inventive lock functions without difficulty even in the case that, as previously mentioned, the restoring force 32 is not sufficient to return the rotary latch 10 from its main latching position 10.3 shown here to its open position 10.1 of FIGS. 1a and 1b, even though the pawl 20 is in its release position, marked by the auxiliary line 20.2, i.e., the position in which the locking point 21 is located outside both the primary latching element 13 and the prelatching element 12 of the rotary latch profile. The reason for this inability, as previously mentioned, can be either that the rotary latch 10 has iced up or that a large amount of snow is weighing down the rear hatch, for which reason this operational situation is called in general the “snow load” situation.

To deal successfully with this snow load situation, it is important not only to design the takeoff wheel 40 in the form of the two previously mentioned disks 41, 42 but also to provide the two disks 41, 42 with the ability to rotate with respect to each other within certain limits. The rotational drive for the takeoff wheel 40 acts on the slider disk 42. For this purpose, as shown in FIGS. 1a and 7a, a toothed segment 39 is provided on the circumference of the slider disk 42. The rotation of the slider disk 42 is transmitted to the cam disk 41 by a separate coupling, the design of which can be best described on the basis of FIGS. 1b and 2.

The coupling is designed as a separate rotational guide, consisting of a pin 17 and a slot 47 in the form of a ring segment. The pin 17 is seated, as FIG. 2 shows, on the inside surface 16 of the slider disk 42, i.e., the side which faces an analogous inside surface 26 of the cam disk 26. As a result, the pin 17 engages in the ring slot 47. Between the two disks 41, 42 there is a torsion spring (not shown), which tries to hold the pin 17 against the first rotational stop 48 as shown in FIG. 1b, this stop being formed by one end of the slot 47. When the slider disk 42 rotates 44 according to FIG. 5a, the rotation 44 is also transmitted to the cam disk 41 by the pin 47, which is resting against the first rotational stop 48, as can be derived from FIG. 5b. This remains in effect until the closed end position 40.2 of the takeoff wheel 40, to be described below, of FIGS. 6a and 6b is reached. To this extent the two disks 41, 42 move in concert with each other, i.e., they act as if they were a single part. In the exemplary embodiment shown here, the limited freedom of rotation of the two disks 41, 42 is important for the following reason.

In the closed end position 40.2, as FIG. 6b illustrates, the closing cam 50 of the takeoff wheel 40 has moved away from the tip 25 of the driver tooth 14. Not only the front edge 52 but also the rear edge 53 of the closing cam 50 are now on the other side of the tip 25 of the driver tooth 14. The closing cam 50 is thus in an “overstroke” position, designated by the distance 54 in FIG. 6b. In this exemplary embodiment of the lock, as the associated FIG. 6a shows, this overstroke is accompanied by a corresponding further movement of the slider 60. Because of its spring-loading 63, the end 61 of the slider is already in its extended position 61.1 in FIG. 5a at the time this overstroke occurs. Because of this overstroke 54, that which occurs in the snow load situation according to FIGS. 7a and 7b now occurs in the normal case as well during the reverse rotation 45 of the takeoff wheel 40 even when the takeoff wheel 40 is in the open end position 40.1. This is what happens in detail:

The process starts from the closed end position 40.2 shown in FIG. 6a. When the motor starts, the reverse rotation 45 causes only the slider disk 42 to move at first in the reverse direction 45 via the toothed segment 39. For this reason, as FIG. 6b shows, the pin 17 also executes this reverse rotation 45. Because of the previously mentioned spring-loading between the two disks 41, 42, the cam disk 41 can also follow this reverse rotation 45 initially over the distance of the overstroke 54, but the cam disk 41 is stopped from rotating any farther as soon as the rear edge 53 of the closing cam 50 strikes the tooth tip 25. Then, as the reverse rotation 45 continues, the pin 17 in FIG. 6b continues to move under no load in the ring slot 47. During this further rotation, the torsion spring located between the two disks 41, 42 is put under tension.

During the course of the reverse rotation 45, however, as already explained on the basis of FIG. 5a, the extended end 61 of the slider, as it passes along its path of rotation designated 38 in FIG. 5a, strikes the release finger 23 and lifts the pawl 20 out of the latch 10 in the manner previously described. When this understanding is also applied to the previously described situation according to FIG. 6b, we see that the tip 25 of the driver tooth 14 also moves away from the rear edge 53 of the cam during the spring-induced reverse rotation 32 of the latch 10. Then the closing cam 50 is free, and the torsion spring acting between the disks 41, 42 rotates the cam disk 41 automatically back into its resting position shown in FIG. 1b, in which the pin 17 rests elastically against the rotational stop 48 again. The closing cam 50 on the one side and the slider 60 on the other are now essentially aligned with each other again in the same angular range of the two-disk takeoff wheel 40. In the snow load situation according to FIGS. 7a and 7b, the following special feature then also plays a role:

The special feature is that, in the snow load situation according to FIG. 7a, the end 61 of the slider remains in its extended position 61.1, even though the pawl 20 is exerting a restoring force 22 on it by way of the release finger 23. That is, in this snow load situation, the slider 60 is not able to slide longitudinally and is instead arrested in its extended position 61.1. To accomplish this, the following simple, space-saving operating means are used in the invention.

As can be seen in FIG. 2, the end 61 of the slider is provided with an axial projection 64, which extends in a direction parallel to the axis 27, indicated in dash-dot line. The axial end surface of this axial projection 64 is emphasized by shading in FIGS. 2, 5b, 6b, and 7b. When the slider 60 is installed in the guide channel 35 of the slider disk 42, the axial projection 64 projects beyond the inside surface 16 of the slider toward the adjacent cam disk 41. As FIG. 3 makes clear, the inside surface 26 of the cam disk 41 is provided with a channel extension 28, into which the axial projection 64 of the slider end 61 can be pushed. This is always the case when the guide channel 35 of the slider disk 42 is aligned with the channel extension 28 of the cam disk 41. Under normal operating conditions, this is always the case during the closing operation. During the opening process, however, this situation exists only during the final phase because of the overstroke 54.

During the reverse rotation 45 explained on the basis of FIG. 6b, the cam disk 41 is stopped as soon as it travels back over the distance of the overstroke 54 and its rear edge 53 meets the tooth tip 25, as previously explained. As rotation 45 continues, the support surface 65 of the axial projection 64, i.e., the surface facing toward the axis 27 in FIG. 2, moves onto a guide segment 49, which is formed by the circular periphery of the cam disk 41. As FIG. 3 shows most clearly, the guide segment 49 proceeds immediately from the opening of the channel extension 28 in the cam disk 41. When the support surface 65 of the axial projection 64 makes contact with this guide segment 55, however, the extended end 61 of the slider can no longer be pushed in. This is especially easy to see in FIG. 7b, which illustrates the snow load situation. Whereas the channel extension 28 remains almost exactly in the closed end position 40.2 according to FIG. 6b, the axial projection 64, emphasized by shading, is carried along positively in the slider disk 42 and thus ultimately arrives in the other, i.e., open, end position 40.1. It is inward-pointing support surface 65 thus travels along the guide segment 55 on the circumference of the cam disk 41 and thus prevents the end 61 of the slider from being pushed in.

In the end position of the snow-load situation according to FIG. 7a, the motor, acting by way of its gear on the toothed segment 39 of the slider disk 42, has returned the slider disk in the direction of the dash-dot arrow 45 in the reverse direction to the previously described open end position 40.1. At the same time, as FIG. 7b shows, the pin 17 seated on the slider disk 42 moves along the ring slot 47 in the blocked cam disk 41 toward the opposite end 49 of the slot. It is not necessary for another rotational stop to occur between 17 and 49. If it is possible to lighten the snow-load pressure acting between the yoke web 31 and the rotary latch 10 by removing the snow from the hatch to such an extent that the restoring spring 32 can cause the rotary latch 10 to rotate back out of its main latching position 10.3 of FIG. 7b and into the open position 10.1 of FIG. 1a, then the tensioned torsion spring between the disks 41, 42 will also pull the cam disk 41 of FIG. 7b in the reverse direction shown by the dash-dot arrow 45. As this happens, the slider disk 42 and its pin 17 remain in the resting position shown in FIGS. 7a and 7b. The cam disk 41 continues to turn until the stop end 48 of its ring slot 47 meets the resting pin 17. Then the channel extension 48, at first still offset in FIG. 7b, is back in alignment with the axial projection 64, emphasized by shading. The support surface 65 of the axial projection 64 is no longer supported and is thus free to move. The restoring force 22 of the pawl 20 can then push the slider end 61 via the release finger 23 back into the takeoff wheel 40. As this happens, the slider moves inward in its guide channel 35, indicated in dotted line in FIG. 7a, and the axial projection 64 enters the aligned channel extension 68. Now the operating conditions illustrated in FIGS. 1a and 1b are restored. The lock is ready for operation again.

### LIST OF REFERENCE NUMBERS

10 rotary latch
10.1 open position of 10 (FIG. 1a)
10.2 prelatching position of 10 (FIG. 4a)
10.3 main latching position of 10 (FIG. 6a)
11 receptacle in 10 for 30
12 prelatching element on 10
13 main latching element on 10
14 driver, driver tooth
15 arrow of the pivoting motion of 10 (FIG. 5)
16 inside surface of 42 (FIG. 2)
17 pin on 41 of the rotational guide
18 axis of rotation of 10
19 lock housing
20 pawl
20.1 ready-to-lock position of 20
20.2 release position, lifted-out position of 20
21 locking point of 20
22 arrow of the spring-loading of 20
23 release finger
24 shoulder on 20
25 tip of tooth 14
26 inside surface of 41
27 axis of the lock (FIG. 2)
28 channel extension in 41 (FIG. 3)
29 bearing axis of 20
30 lock yoke
31 yoke web of 30
32 arrow of the spring-loading of 10
33 automobile body
34 arrow of the closing movement of a hatch
35 channel, guide channel in 42 for 60 (FIG. 2)
36 peripheral contour of 42
37 support zone for 23 on 42 (FIG. 2)
38 arrow of the rotation of 61 (FIG. 5a)
39 toothed segment on 42 (FIGS. 1a, 7a)
40 takeoff wheel
40.1 open end position of 40
40.2 closed end position of 40
41 disk, cam disk
42 disk, slider disk
44 first travel direction of 40, rotation
45 second, reverse travel direction of 40, reverse rotation
46 end surface of 41
47 ring segment-like slot in 41 of the rotational guide
48 first rotational stop in 47 for 17 (FIG. 1b)
49 second end of 47 for 17 (FIGS. 7b, 3)
50 takeoff element for the closing process, closing element, closing cam
51 rotational path of 50 (FIG. 5b)
52 front edge of 50 (FIG. 6b)
53 rear edge of 50 (FIG. 6b)
54 overstroke of 50 (FIG. 6b)
55 guide segment, periphery of 41 (FIGS. 2, 7)
60 takeoff element for the opening process, opening element, slider
61 end of slider 60 (FIGS. 2, 5a)
61.1 extended position of 61 (FIG. 5a)
61.2 retracted position of 61 (FIG. 1a/4a)
62 spring
63 arrow of the spring force of 62 acting on 60 (FIG. 6a)
64 axial projection on 61 (FIG. 2)
65 support surface on 64 (FIG. 2)

1. Lock, especially for automobile doors, hatches, etc.,
with a rotary latch (10), which has a prelatching element (12) and a main latching element (13) and which is spring-loaded (32) in the direction toward its open position (10.1), in which the door is open;
with a stationary pin, yoke (30), or the like, which, as the door is being closed, travels into the rotary latch (10), thus pivoting the latch into a prelatching position (10.2), where a spring-loaded (22) pawl (20) drops into the prelatching element (12) of the rotary latch (10);
with a combination motorized closing and opening aid for the door, comprising a gear with two takeoff elements (50, 60), which can be put into motion simultaneously, and a control unit;
where, by means of the control unit, the first takeoff element functions as a closing element (50) with the gear turning in one direction (44) as the door is being pulled shut, the rotary latch (10) thus being pivoted out of its prelatching position (10.2) into the main latching position (10.3);
where the pawl (20) drops into the main latching element (13) of the rotary latch (10) and the door is closed; and
in the other direction of rotation, i.e., with the gear turning in the opposite direction (45), the second takeoff element functions as an opening element (60) as the door is being opened, the pawl (20) thus being lifted up out of the rotary latch (10);
as a result of which the released rotary latch (10) rotates back into its open position (10.1) under the effect of its spring-loading (32),
wherein
the two takeoff elements (50, 60) are seated with a certain axial offset from each other on a common takeoff wheel (40); in that
the closing element (50) is located in the lock in a first plane of rotation, namely, in a closing plane; in that
the opening element (60) responsible for the opening process lies in a second plane of rotation in the lock, namely, in an opening plane, which is axially offset from the first plane of rotation; in that
for the closing element (50), the rotary latch (10) has a driver (14) located in the closing plane, the driver being located outside the path of rotation (51) of the closing element (50) when the rotary latch (10) is in the open position (10.1); in that
conversely, the driver (14) is located in the path of rotation (51) of the closing element when the rotary latch (10) is in the prelatching position (10.2) and also when it is in the main latching position (10.3); in that
a release finger (23) for the opening element (60) is seated on the pawl (20), the release finger being located in the opening plane; and in that
the opening element (60) is mounted with spring-loading (63) in the takeoff wheel (40) and, as a result of its spring-loading (63), shifts automatically between a retracted position (61.2), in which it is inactive with respect to the release finger (23), and an extended position (61.1), in which it is active with respect to the release finger (23).

2. Lock according to claim 1, wherein the takeoff wheel (40) is turned by the control unit in two directions of movement (44, 45) between two stable end positions (40.1, 40.2), namely, between a closed end position (40.2) when the door is closed and an open end position (40.1) when the door is open.

3. Lock according to claim 1, wherein the closing element (50) is located outside the plane of rotation of the takeoff wheel (40).

4. Lock according to claim 1, wherein the opening plane of the opening element (60) is located at least partially in the plane of rotation of the takeoff wheel (40).

5. Lock according to claim 1, wherein the closing element is formed by a cam (closing cam 50) projecting from the takeoff wheel (40), and the driver is formed by a driver tooth (14) projecting from the rotary latch (10).

6. Lock according to claim 5, wherein the closing cam (50) projects axially from the end surface (46) of the takeoff wheel (40).

7. Lock according to claim 5, wherein the rotary latch (10) lies in the closing plane, and its driver tooth (14) is formed by a profiled part on the periphery of the rotary latch (10).

8. Lock according to claim 5, wherein at least the locking point (21) of the pawl (20) which drops into the prelatching element (12) or main latching element (13) of the rotary latch (10) lies in the closing plane, whereas the release finger (23) lies in the offset opening plane.

9. Lock according to claim 1, wherein the spring-loaded opening element (60) is in its retracted position (61.2) only when the takeoff wheel (40) is in the area of the open end position (40.1).

10. Lock according to claim 1, wherein the spring-loaded opening element consists of a slider (60), which can slide longitudinally in the takeoff wheel (40), where the end (61) of the slider tries to reach the extended position (61.1) under the action of its spring-loading (63).

11. Lock according to claim 9, wherein, when the end (61) of the slider is in the extended position (61.1), it projects radially beyond the periphery of the takeoff wheel (40).

12. Lock according to claim 10, wherein the takeoff wheel (40) has a channel (35) for the longitudinal guidance of the slider (60).

13. Lock according to claim 12, wherein the guide channel (35) extends essentially along a diameter of the takeoff wheel (40).

14. Lock according to claim 1, wherein, at least in the normal case, the end (61) of the slider and the closing cam (50) are both located in essentially the same angular region of the takeoff wheel (40).

15. Lock according to claim 1, wherein the takeoff wheel (40) consists of two movable disks (41, 42), namely, a slider disk (42), which holds the opening element or the slider (60), and a disk with the closing element or with the closing cam (50), namely, a cam disk (41), the two disks being able to rotate relative to each other to a limited extent under certain conditions.

16. Lock according to claim 15, wherein the rotary drive of the takeoff wheel (40) acts on the slider disk (42); in that
the rotation of the slider disk (42) is transmitted to the cam disk (41) by means of an intermediate coupling; in that
the coupling, upon rotation of the slider disk (42) in the one direction, namely, the direction (44) which determines the door-closing process, always carries the cam disk (41) along with it; and in that
upon rotation of the slider disk (42) in the reverse direction (45), i.e., the direction which determines the opening process, the cam disk (41) can be disconnected under certain conditions and thus will rest, whereas the slider disk (42), when disconnected from the cam disk, will continue to rotate in reverse (45) by itself.

17. Lock according to claim 16, wherein, between the two disks (41, 42) there is a torsion spring, which tries to turn the disconnected cam disk (41) back into a defined starting rotational position with respect to the slider disk (42).

18. Lock according to claim 16, wherein the coupling consists of a rotational guide (17, 27), and in that
a rotational stop (48) is located at one end of the rotational guide (17, 27).

19. Lock according to claim 17, wherein the spring located between the two disks (41, 42) tries to bring the rotational guide (17, 47) into contact with the rotational stop (48).

20. Lock according to claim 18, wherein the rotational guide consists of
a pin (17) on the slider disk (42) or on the cam disk; and of
a slot (47), in the form of a ring segment, in the cam disk (41) or in the slider disk, in which the pin (17) is guided.

21. Lock according to claim 1, wherein, during the motorized closing process, the takeoff wheel (40) continues to turn beyond the position where the locking point (21) of the pawl (20) is aligned with the main latching element (13) of the rotary latch (10) until it reaches the closed end position (40.2) and thus produces a so-called overstroke (54), and in that, during this overstroke (54), the pawl (20) has sufficient time to drop reliably behind the main latching element (13) of the rotary latch (10).

22. Lock according to claim 21, wherein, when the takeoff wheel (40) is in the closed end position (40.2), the closing cam (50) grips the tip (25) of the driver tooth (14) of the rotary latch (10).

23. Lock according to claim 22, wherein, in a so-called “snow load situation”, where, after reverse rotation of the takeoff wheel (40) in the reverse direction (45), the spring-loading (32) is not sufficient to pivot the released rotary latch (10) back into its open position (10.1), the closing cam (51), upon reverse rotation (45) of the takeoff wheel (40), strikes the tip (25) of the driver tooth (14) and stops the further accompanying rotation of the cam disk (41); in that, however,
the slider disk (42) continues to turn back until it reaches the open end position (40.1), during which the cam disk (41) becomes disconnected in the rotational guide (17, 47) and tensions the torsion spring; and in that
the end (61) of the slider continues to be arrested in its extended position (61.1) and thus, upon reverse rotation (45) of the slider disk (42), lifts the pawl (40) out of the rotary latch (10) and then holds it in the lifted-out position (20.2)
until the free rotary latch (10) has pivoted back into its open position (10.1).

24. Lock according to claim 23, wherein, after the rotary latch (10) has pivoted back, the end (61) of the slider is pushed back by the pawl (20) into its retracted position (61.2) in the slider disk (42).

25. Lock according to claim 23, wherein
the slider (60) has a support surface (65), which faces in the direction opposite that of its spring-loading (63); in that
a guide segment (55) in the form of at least a part of a circle on the cam disk (42) is assigned to the support surface (65), the partial circle being essentially coaxial to the axis of rotation (27) of the disk; in that
the support surface (65) is normally outside the guide segment (55) and thus allows the slider (60) to be pressed inward; in that, however,
in the snow load situation, upon reverse rotation of the slider disk (42), the support surface (65) slides along the guide segment (55) of the resting cam disk (41) until the slider disk (42) reaches the open end position (40.1); in that
the support surface (65) resting on the guide segment (55) arrests the end (61) of the slider in its extended position (61.1) until the spring-loaded rotary latch (10) has pivoted back into its open position (10.1); and in that
in the open position (10.1) of the rotary latch, the slider (60) can be pressed in again when the torsion spring of the rotational guide (17, 47) has turned the cam disk (41) back so far that the support surface (65) on the slider (60) has traveled beyond the guide segment (55) on the cam disk (41).

26. Lock according to claim 25, wherein the guide segment (55) is provided by the periphery of the cam disk (42).

27. Lock according to claim 24, wherein
the channel (35) serving to guide the longitudinal travel of the slider (60) is located in the slider disk (42); in that
the end (61) of the slider has a projection (axial projection 64) extending beyond the thickness of the slider disk (60) in a direction parallel to the axis of rotation (27); in that
a channel extension (28) on the inside surface (26) of the cam disk (41) is assigned to the slider projection (64),
into which channel extension the axial projection (64) normally travels when the slider (60) moves into its retracted position (61.2); in that
the partial segment (55) of a circle on the cam disk (41) is adjacent to the channel extension (28); and in that
a shoulder surface between the axial projection (64) at the end (61) of the slider forms the support surface (65), which is supported against the cam disk (41) in the snow load situation.
